(19) United States
(12) Patent Application Publication
(10) Pub. No.: US 2026/0233192 A1
(43) Pub. Date: Aug. 13, 2026

(54) SORBENTS FOR CARBON DIOXIDE CAPTURE

(71) Applicant: UCHICAGO ARGONNE, LLC, Chicago, IL (US)

(72) Inventors: Zachary D. HOOD, Bolingbrook, IL (US); Sixbert P. MUHOZA, Bolingbrook, IL (US); Shiba P. ADHIKARI, Lisle, IL (US)

(73) Assignee: UCHICAGO ARGONNE, LLC, Chicago, IL (US)

(21) Appl. No.: 19/532,504

(22) Filed: Feb. 6, 2026

Related U.S. Application Data
(60) Provisional application No. 63/755,585, filed on Feb. 7, 2025.

(51) Int. Cl. B01J 20/02; B01D 53/04; B01J 20/28; B01J 20/34

(52) U.S. Cl. CPC B01J 20/0211; B01D 53/0462; B01J 20/28004; B01J 20/3433; B01J 20/3483; B01D 2253/112; B01D 2257/302; B01D 2257/304; B01D 2257/504

(57) ABSTRACT

A composition includes a MXene and a compound sorbed to the MXene. The MXene includes Tₓ. Tₓ is a surface termination comprising NH₂, R¹NH₂, or a combination thereof, wherein R¹ is a C₁₋₅ alkyl group. The compound sorbed to the MXene includes CO₂, H₂S, SO_{y}, or a combination of any two or more thereof, wherein y is 1 to 4.

### CROSS-REFERENCE TO RELATED APPLICATIONS

This application claims the benefit of and priority to U.S. Provisional Patent Application No. 63/755,585, filed Feb. 7, 2025, the entire contents of which are incorporated herein by reference.

### GOVERNMENT RIGHTS

This invention was made with government support under Contract No. DE-AC02-06CH11357 awarded by the United States Department of Energy to UChicago Argonne, LLC, operator of Argonne National Laboratory. The government has certain rights in the invention.

### FIELD

The present technology is generally related to MXenes, a family of two-dimensional transition metal carbides, nitrides, and/or carbonitrides, terminated with amines useful for carbon dioxide sorption.

### BACKGROUND

Net zero carbon emissions may be a foundational factor for limiting global warming.

### SUMMARY

An aspect of the present disclosure is directed to a composition including a MXene comprising Tₓ, wherein Tₓ is a surface termination, the surface termination comprising NH₂, R¹NH₂, or a combination thereof, wherein R¹ is a C₁₋₅ alkyl group; and a compound sorbed to the MXene, the compound including CO₂, H₂S, SO_{y}, or a combination of any two or more thereof, wherein y is 1 to 4.

Another aspect of the present disclosure is directed to a method including contacting a MXene with a compound while the MXene is at a first temperature of about −78° C. to about 40° C., thereby sorbing the compound to the MXene; wherein the MXene comprises Tₓ, Tₓ is a surface termination, and the surface termination comprises NH₂, R¹NH₂, or a combination thereof, wherein R¹ is a C₁₋₅ alkyl group; and wherein the compound includes CO₂, H₂S, SO_{y}, or a combination of any two or more thereof, wherein y is 1 to 4.

Another aspect of the present disclosure is directed to a system including a plurality of MXene particles comprising Tₓ, wherein Tₓ is a surface termination, the surface termination comprising NH₂, R¹NH₂, or a combination thereof, wherein R¹ is a C₁₋₅ alkyl group; a vessel configured to contain the plurality of MXene particles, the vessel comprising at least one port for influx of a compound; and a cooling device configured to cool the plurality of MXene particles at a first temperature of about −78° C. to about 40° C.; wherein the compound comprises CO₂, H₂S, SO_{y}, or a combination of any two or more thereof, wherein y is 1 to 4.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is an illustration of an amine-terminated MXene sorbent with a compound sorbed thereto.

FIG. 2 is a schematic of a system for compound sorption using the amine-terminated MXene sorbent.

FIG. 3A is an X-ray diffraction (“XRD”) graph of the Ti₃AlC₂ MAX phase.

FIG. 3B is a scanning electron microscopy (“SEM”) image of the MAX phase in FIG. 3A.

FIG. 4A is a graph of Raman spectroscopy of Ti₃C₂Br₂ MXene.

FIG. 4B is an SEM image of the Ti₃C₂Br₂ MXene in FIG. 4A.

FIG. 5A is a graph of energy-dispersive X-ray spectroscopy (“EDS”) of amine-terminated Ti₃C₂—NH₂ MXene.

FIG. 5B is a graph of EDS of amine-terminated Ti₃C₂—C₂H₅NH₂ MXene.

FIG. 5C is an SEM image of the Ti₃C₂—NH₂ MXene in FIG. 5A.

FIG. 5D is an SEM image of the Ti₃C₂—C₂H₅NH₂ MXene in FIG. 5B.

FIG. 6A is a graph of the Ti 2p peak in X-ray photoelectron spectroscopy (“XPS”) of the Ti₃C₂—NH₂ MXene in FIG. 5A and the Ti₃C₂—C₂H₅NH₂ MXene in FIG. 5B (referred to as “MXene-NHR”).

FIG. 6B is a graph of the Br 3d peak in XPS of the Ti₃C₂—NH₂ MXene in FIG. 5A and the Ti₃C₂—C₂H₅NH₂ MXene in FIG. 5B (referred to as “MXene-NHR”).

FIG. 6C is a graph of the N is peak in XPS of the Ti₃C₂—NH₂ MXene in FIG. 5A and the Ti₃C₂—C₂H₅NH₂ MXene in FIG. 5B (referred to as “MXene-NHR”).

FIG. 7 is a graph of CO₂ desorption from Ti₃C₂Br₂ MXene (“MXene-Br”), Ti₃C₂—NH₂ MXene (“MXene-NH2”), and Ti₃C₂—C₂H₅NH₂ MXene (“MXene-NHR”) as measured by thermogravimetric analysis (“TGA”).

FIG. 8 is a graph of CO₂ adsorption and desorption from Ti₃C₂Br₂ MXene (“MXene-Br”), Ti₃C₂—NH₂ MXene (“MXene-NH2”), and Ti₃C₂—C₂H₅NH₂ MXene (“MXene-NR”).

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments, and does not pose a limitation on the scope of the claims unless otherwise stated. No language in the specification should be construed as indicating any non-claimed element as essential.

As used herein the term “sorbed” and its variants are to be construed to mean taken up and held by adsorption, absorption, or the combination thereof.

Carbon dioxide (CO₂) capture and sequestration, along with industrial decarbonization, holds tremendous potential for mitigating the current energy and environmental challenges. In this context, CO₂ capture technologies may help establish a more sustainable carbon cycle.

Conventional technology to capture CO₂ includes amine-functionalized sorbents. Amine groups may have a higher affinity for CO₂ because these groups may create favorable intermediates (e.g., carbamic acid and ammonium carbamate) with CO₂. CO₂ adsorption by amine-functionalized sorbent may typically include a two-step cycle, including (1) CO₂ adsorption to the amine-functionalized sorbent, forming favorable intermediates, and (2) regeneration, where the adsorbed CO₂ is released from the amine-functionalized sorbent for further storage and/or utilization of the CO₂. Regeneration usually includes heating the sorbent to higher temperatures of, for example 90° C. or more, to desorb the CO₂ from the amine-functionalized sorbent, leading to high energy usage for this step of the process (e.g., about 2000 kJ/kg CO₂ to about 50000 kJ/kg CO₂). Furthermore, conventional amine-functionalized sorbents may have insufficient CO₂ adsorption capacities of less than 10 mmol CO₂ per gram sorbent (e.g., about 1 mmol CO₂ per gram sorbent to about 7 mmol CO₂ per gram sorbent).

Disclosed herein are CO₂ capture materials, systems, and processes that address these deficiencies in the existing CO₂ capture technology. Specifically, the CO₂ capture materials disclosed herein include amine-terminated MXenes for CO₂ sorption. Amine-terminated MXenes include amine groups in their molecular structure as surface terminations, which may provide higher concentrations of amine group available for CO₂ capture, thereby improving CO₂ capture efficiency. Furthermore, amine-terminated MXenes may have lower regeneration energy than conventional amine-functionalized sorbents because, as solid sorbents, they may not need solvent regeneration typical of amine scrubbers, thereby foregoing a heating regeneration step.

MXenes are a class of layered (2D) materials that include transition metal carbides and/or nitrides. The amine-terminated MXenes disclosed herein have a general formula of Mₙ₊₁XₙTₓ (1≤n≤4), where M represents an early transition metal, X represents carbon and/or nitrogen, Tₓ (or T) represents amine surface termination groups NH₂, R¹NH₂, or a combination thereof, wherein R¹ is a C₁₋₅ alkyl group. Tₓ can be present in an amount based on charge balance of the MXene. In some embodiments, the MXenes may include Tₓ of NH₂, R¹NH₂, OH, or a combination of any two or more thereof. The tunable surface chemistry, as well as the ordered structure of MXenes, may allow for tailoring the sorption of CO₂.

MXenes are a family of two-dimensional carbides, nitrides, and carbonitrides. They possess metallic electronic conductivity, large surface area, and versatile surface chemistry, all of which are desirable properties for electrocatalytic processes. As illustrated by their general formula, Mₙ₊₁XₙTₓ, MXenes include n+1 layers of early transition metals (“M”) interleaved with n layers of carbon and/or nitrogen (“X”) with the outer layers terminated by amine surface groups (Tₓ=NH₂, R¹NH₂, or a combination thereof, wherein R¹ is a C₁₋₅ alkyl group).

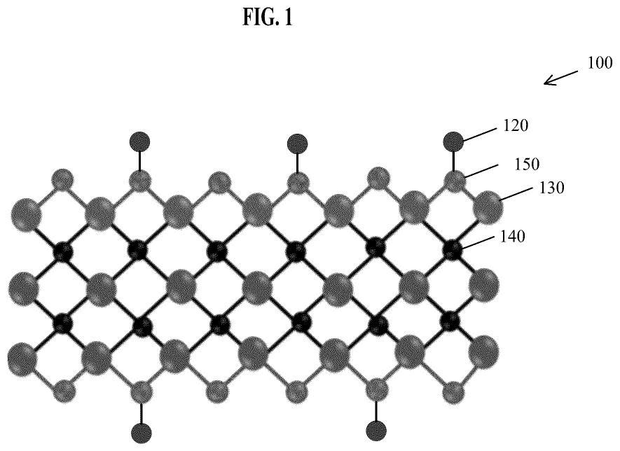

FIG. 1 is an illustration of an amine-terminated MXene 100 sorbent with a compound 120 sorbed thereto. The MXene includes transition metal (“M”) atoms 130, carbon and/or nitrogen (“X”) atoms 140, terminal amine surface groups (“Tₓ”) 150. The compound 120 may be sorbed to the MXene at the amine surface group (“Tₓ”) 150, forming a complex. For example, the amine and the carbon dioxide may react to form a carbamate.

An aspect of the present disclosure is directed to a composition including a MXene comprising Tₓ, wherein Tₓ is a surface termination, the surface termination comprising NH₂, R¹NH₂, or a combination thereof, wherein R¹ is a C₁₋₅ alkyl group. The MXene may include a compound sorbed to the MXene. The compound may include CO₂, H₂S, SO_{y}, or a combination of any two or more thereof, wherein y is 1 to 4. For example, the MXene may include CO₂ sorbed thereto.

The MXene may be selected from M₂XTₓ, M₃X₂Tₓ, M₄X₃Tₓ, and M₅X₄Tₓ, wherein M comprises at least one transition metal and X is selected from carbon and nitrogen. The transition metal may be selected from scandium, titanium, vanadium, chromium, yttrium, zirconium, niobium, molybdenum, hafnium, tantalum, and tungsten. For example, the transition metal may be titanium. For example, the MXene may include Ti₃C₂NH₂ or Ti₃C₂R¹ where R¹ is a C₁₋₅ alkyl group, or a combination thereof. For example, the MXene may include Ti₃C₂—C₂H₅NH₂.

The MXene may be in the form of particles. The particles may have a at least one dimension of about 1 μm to about 100 μm (e.g., about 1 μm to about 80 μm, about 1 μm to about 60 μm, about 1 μm to about 40 μm, about 1 μm to about 20 μm) as characterized by scanning electron microscopy.

Another aspect of the present disclosure is directed to a method including contacting a MXene with a compound while the MXene is at a first temperature of about −78° C. to about 40° C., thereby sorbing the compound to the MXene. The MXene may comprise Tₓ, where Tₓ is a surface termination, and the surface termination comprises NH₂, R¹NH₂, or a combination thereof, wherein R¹ is a C₁₋₅ alkyl group. The compound contacting the MXene may include CO₂, H₂S, SO_{y}, or a combination of any two or more thereof, wherein y is 1 to 4. The method may include sorbing the compound to the MXene.

The method may include cooling the MXene at the first temperature of about −78° C. to about 20° C. (e.g., about −77° C. to about 20° C., about −20° C. to about 20° C., about −20° C. to about 10° C., about −18° C. to about 10° C., about 0° C. to about 10° C., or about 3° C. to about 5° C., about −78° C., about −18° C., about 4° C., about 10° C., about 20° C., or any value or subrange therebetween).

The method may further include heating the MXene with the compound sorbed thereto to a second temperature to desorb the compound from the MXene. The second temperature may be about 30° C. to about 120° (e.g., about 40° C. to about 120° C., about 50° C. to about 120° C., about 60° C. to about 120° C., about 70° C. to about 120° C., about 70° C. to about 110° C., about 40° C. to about 80° C., about 40° C. to about 60° C., about 50° C. to about 80° C., about 50° C. to about 60° C., or any value or subrange therebetween).

Another aspect of the present disclosure is directed to a system including a plurality of MXene particles comprising Tₓ, wherein Tₓ is a surface termination, the surface termination comprising NH₂, R¹NH₂, or a combination thereof, wherein R¹ is a C₁₋₅ alkyl group; a vessel configured to contain the plurality of MXene particles, the vessel comprising at least one port for influx of a compound; and a cooling device configured to cool the plurality of MXene particles at a first temperature of about −78° C. to about 40° C. and a pressure of about 0.5 bar to 5 bar (e.g., 0.1 bar to 1 bar, or about 1 bar); wherein the compound comprises CO₂, H₂S, SO_{y}, or a combination of any two or more thereof, wherein y is 1 to 4.

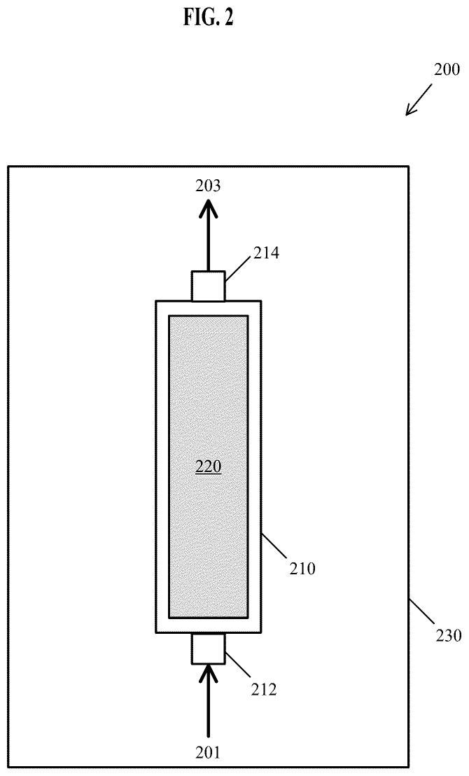

FIG. 2 is a schematic of the system 200 for compound sorption using the amine-terminated MXene sorbent 220. The system includes a vessel 210, in which the MXene sorbent 220 is disposed. The vessel 210 may include inlet 212 and outlet 214 to provide a flow of the compound (CO₂, H₂S, SO_{y}, or a combination of any two or more thereof) in gaseous form through the MXene sorbent 220. At least a portion of the vessel 210 may be disposed in, near, or on a cooling device 230 configured to cool the plurality of MXene particles at the first temperature.

Nonlimiting examples of the cooling device include, but are not limited to, a thermoelectric cooler (also known as a Peltier device), a cryocooler, a vapor-compression refrigerator, an absorption refrigerator, dry ice, an evaporative cooler, a heat sink, a heat pump, a jet impingement cooling system, a cryogenic gas expansion system, or any combination of two or more thereof.

The cooling device may further be configured to heat the plurality of MXene particles at a second temperature of about 30° C. to about 120° C. (e.g., about 40° C. to about 120° C., about 50° C. to about 120° C., about 60° C. to about 120° C., about 70° C. to about 120° C., about 70° C. to about 110° C., about 40° C. to about 80° C., about 40° C. to about 60° C., about 50° C. to about 80° C., about 50° C. to about 60° C., or any value or subrange therebetween). Nonlimiting examples of the cooling device include, but are not limited to, a thermoelectric module (also known as a Peltier device), a heat pump, a reversible absorption refrigerator/heater, a vapor compression refrigeration system with heat recovery, a chiller-heat pump system, a dual-mode air conditioner, a hydronic heating and cooling system, a reversible fan coil unit, or a combination of any two or more thereof.

The system may further include a heater configured to heat the plurality of MXene particles at a second temperature of about 30° C. to about 120° C. (e.g., about 40° C. to about 120° C., about 50° C. to about 120° C., about 60° C. to about 120° C., about 70° C. to about 120° C., about 70° C. to about 110° C., about 40° C. to about 80° C., about 40° C. to about 60° C., about 50° C. to about 80° C., about 50° C. to about 60° C., or any value or subrange therebetween). Nonlimiting examples of the heater include, but are not limited to, electric heater (also known as a resistive heating element), thermoelectric heater, induction heater, heat pump, infrared heater, microwave heater, hydronic heating system, convection heater, oil-filled radiator, solar thermal collector, steam-based heating system, or a combination of any two or more thereof.

In any embodiment, the system may use atmospheric temperatures to cool the plurality of MXene particles at the first temperature and/or to heat the plurality of MXene particles at the second temperature.

The vessel may include a column, a pipe, a tank, a shipping container, a vat, a flue, a silo, a tower, or a combination of any two or more thereof. For example, the vessel may include a column (e.g., a packed-bed column, fluidized bed column) comprising two ports configured for flow of the compound through the column.

The present invention, thus generally described, will be understood more readily by reference to the following examples, which are provided by way of illustration and are not intended to be limiting of the present invention.

### Examples

Materials. Ti (325 mesh, 99.5%, Beantown Chemical), Al (325 mesh, 99.5%, Beantown Chemical), and TiC (99.5%, Beantown Chemical), CdBr₂ (99%, Thermo Fisher Scientific), HBr (47.0-49.0%, Beantown Chemical), CsBr (99%, Thermo Fisher Scientific), KBr (99%, Sigma-Aldrich), LiBr powder (99.1%, AmBeed), NaNH₂ (99%, Thermo Fisher Scientific), N₂H₄ (99+%, Thermo Fisher Scientific), acetonitrile (MeCN) (99.8%, Sigma-Aldrich), methanol (MeOH, 99.8%, WWR Chemicals), n-Butyllithium (2.5 M in hexanes, Sigma-Aldrich), ethylamine (70% wt. % in water, Beantown Chemical), toluene (99%, Thermo Fisher Scientific). All samples were synthesized and stored in an argon-filled glovebox.

Synthesis of MAX Phase (Ti₃AlC₂). The Ti₃AlC₂ MAX phase was synthesized by ball milling TiC, Al, and Ti in a 2:1:1 molar ratio. It was then sintered at 1380° C. for four hours under the flow of argon gas.

Synthesis of Bromine-terminated MXene (Ti₃C₂Br₂). Ti₃AlC₂ and CdBr₂ were mixed with a mortar and pestle in a 1:8 molar ratio. The mixture was then heated in an alumina crucible at 610° C. for 14 hours. HBr was used to dissolve the excess Cd and CdBr₂ after the reaction for 24 hours. The sample was rinsed with deionized water using vacuum filtration and then dried under vacuum at 60° C. overnight.

Synthesis of Ti₃C₂—NH₂ MXene. Ti₃C₂Br₂, CsBr, KBr, and LiBr were mixed in an alumina crucible in a 1.5:25:18.9:56.1 molar ratio. The mixture was heated at 300° C. for an hour, becoming molten. NaNH₂ was stirred in, and the sample was stirred for another two hours, causing bromine etching by the molten salt mixture. The sample was then cooled down to room temperature overnight. N₂H₄ was added and stirred to dissolve the solid. The sample was then washed with anhydrous MeCN and MeOH using vacuum filtration and then dried under vacuum at 60° C. overnight (about 12 hours).

Synthesis of Ti₃C₂—C₂H₅NH₂ MXene. Ti₃C₂Br₂, n-butyllithium, and ethylamine were combined in a 1:4.5:3 molar ratio in a glass tube with a stir bar. The mixture was then heated at 120° C. in an oil bath for two days while being stirred. The resulting Ti₃C₂—C₂H₅NH₂ sample was rinsed with anhydrous toluene and anhydrous MeOH using vacuum filtration and then dried under vacuum at 60° C. overnight.

Material Characterization. Powder X-ray diffraction (“PXRD”) was used for phase identification using a Bruker D8 Advance X-ray diffractometer equipped with a Cu K-α radiation. The samples were packed into sample holder wells and scanned for 15 minutes between 5° and 80°. Scanning electron microscopy (“SEM”) images and electron diffraction spectroscopy (“EDS”) analyses were collected using a Phenom XL desktop SEM and EDS instrument at 10 kV. X-ray photoelectron spectroscopy (“XPS”) data were collected with a Thermo K-Alpha+ surface analysis system equipped with Al K-α radiation. Ar⁺ ion beam etching was carried out with 4 eV at a 0.2 eV per step resolution and a total integration time of 0.1 second per point. All XPS spectra were deconvoluted using the Thermo Advantage v5.9931 software package with adventitious carbon (284.8 eV) as the charge reference. Raman spectroscopy data were collected using AIRsight Shimadzu Raman/FTIR Spectrometer.

CO₂ Capture Evaluation. The MXenes were heated in an oven at 75° C. for 30 minutes prior to being purged with CO₂ to remove any water in the samples. The samples were then placed in a vessel, which was then purged with CO₂ gas for one minute, sealed, and set in a refrigerator at 2.22° C. for 30 minutes to provide time for the MXenes to saturate with CO₂. 0.10 mg of CO₂-saturated MXenes was added to the stage of the thermogravimetric analysis instrument and the thermogravimetric analysis (“TGA”) was carried out using a Discovery TGA 55 Thermal Analyzer.

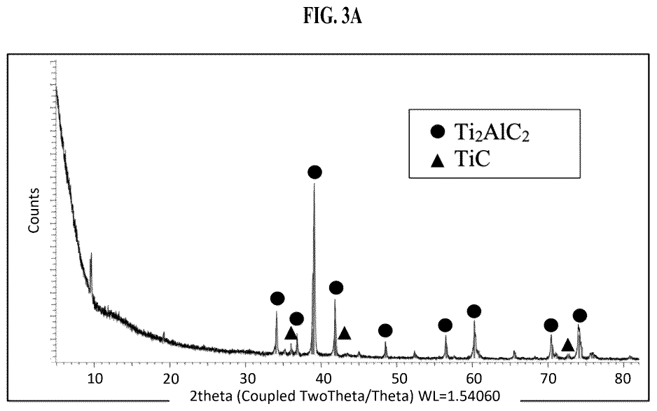

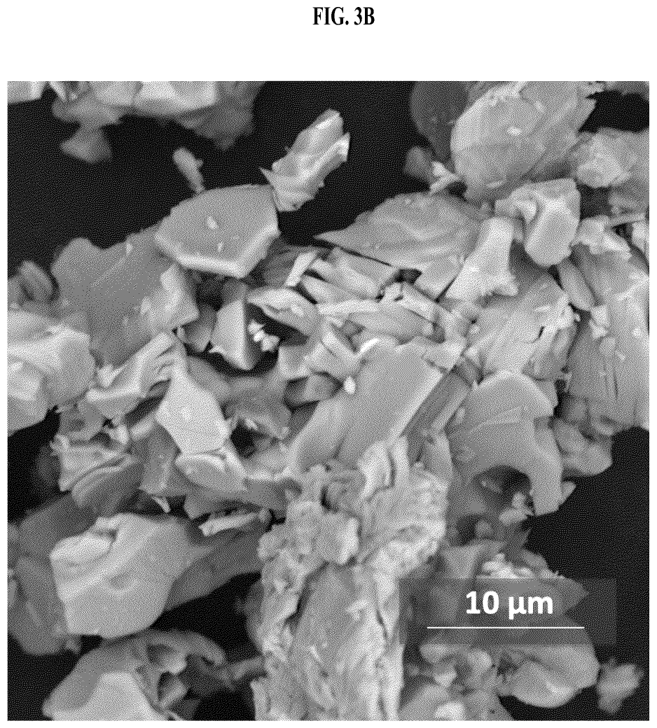

Synthesis and Characterization of the MAX Phase. FIG. 3A is an X-ray diffraction (“XRD”) graph of the Ti₃AlC₂ MAX phase. The XRD graph indicates that the synthesis of the Ti₃AlC₂ MAX phase provided the Ti₃AlC₂ MAX phase. The predominant peaks, indicated as larger peaks labeled with circles, were characteristic of the Ti₃AlC₂ MAX phase. The smaller peaks labeled with triangles corresponded to TiC, which may indicate the presence of excess TiC in the sample. The peaks observed were sharp and thin, indicating that the sample had a crystalline structure.

FIG. 3B is a scanning electron microscopy (“SEM”) image of the MAX phase in FIG. 3A. The SEM image of the Ti₃AlC₂ indicated layered particles with well-defined edges, indicating a layered structural morphology. The particles had a uniform size of about 1 μm to about 50 μm and uniform shape. Most of the sample appeared homogeneous and smooth, indicating successful sintering.

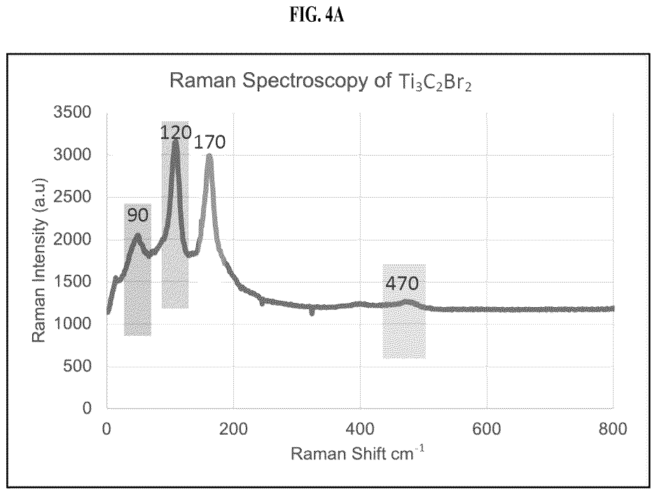

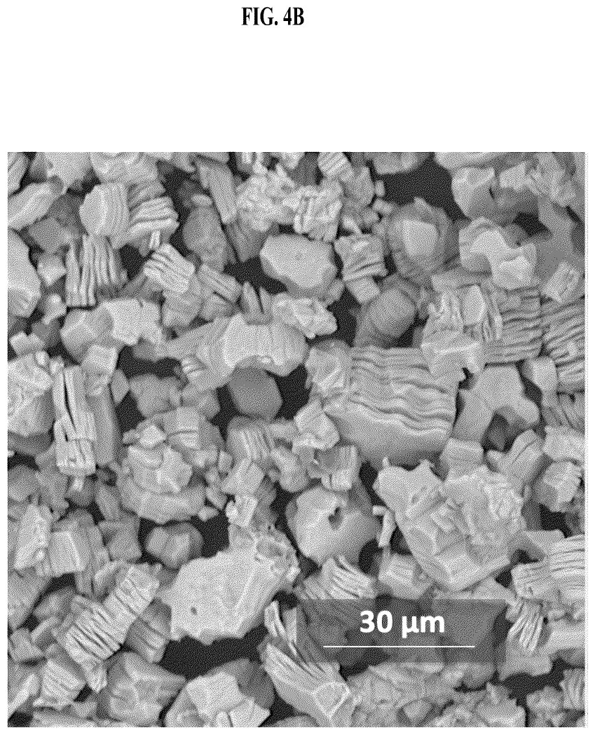

Synthesis and Characterization of MXene (Ti₃C₂Br₂). FIG. 4A is a graph of Raman spectroscopy of Ti₃C₂Br₂ MXene. Raman spectroscopy shows a pattern characteristic for Ti₃C₂Br₂ MXenes. The peak around 90 cm⁻¹ indicated in-plane vibrations from the bromine surface termination. The peak at 120 cm⁻¹ indicated the Ti₃C₂ MXene. The peak at 170 cm⁻¹ and the peak at 470 cm⁻¹ indicate out-of-plane vibrations from the bromine surface termination.

FIG. 4B is an SEM image of the Ti₃C₂Br₂ MXene in FIG. 4A. The SEM indicated the Ti₃C₂Br₂ had an accordion-like layered morphology, indicative of MXenes. The sample appeared homogeneous and smooth where it was not layered, indicating successful sintering. The particles of MXene had a uniform shape of about 5 μm to about 50 μm and uniform distribution.

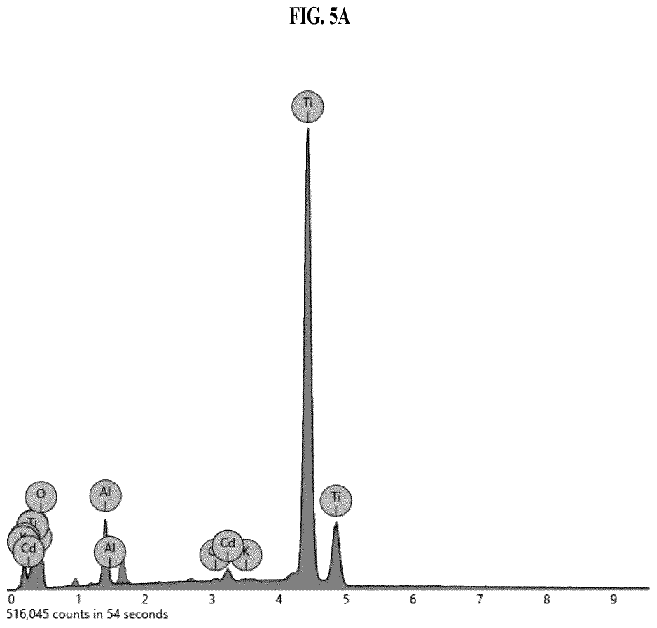

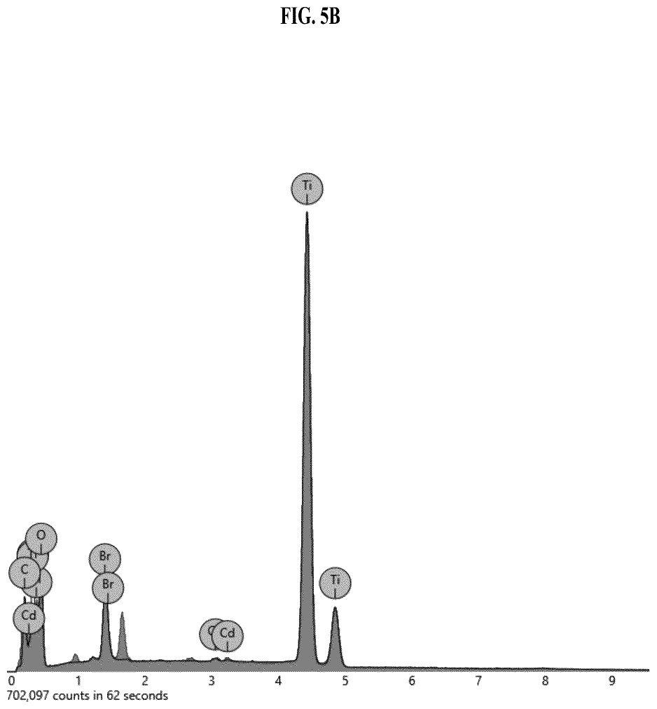

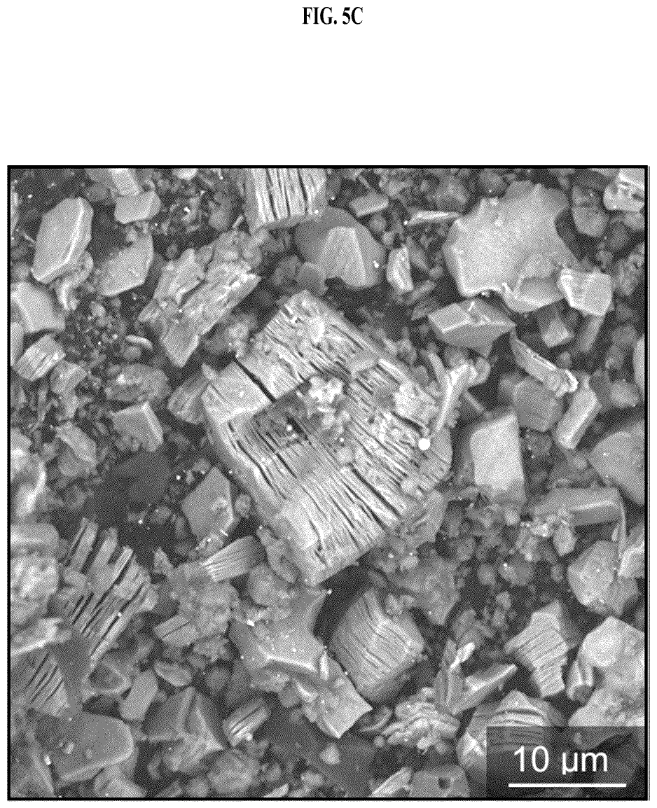

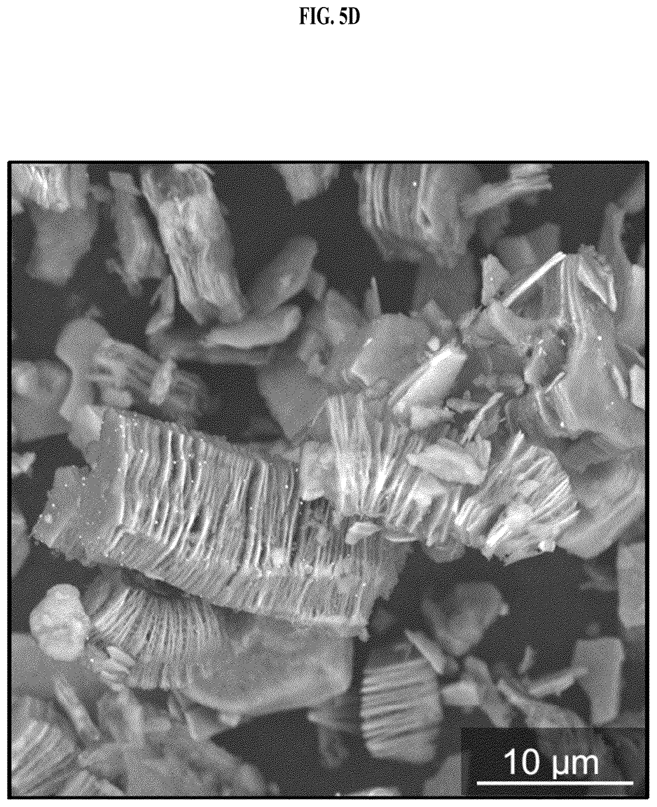

FIG. 5A is a graph of energy-dispersive X-ray spectroscopy (“EDS”) of amine-terminated MXene Ti₃C₂—NH₂. FIG. 5B is a graph of EDS of amine-terminated MXene Ti₃C₂-C₂H₅NH₂. The EDS graphs of Ti₃C₂—NH₂ and Ti₃C₂—C₂H₅NH₂ did not include peaks for bromine, indicating that bromine was successfully substituted by amine groups. The sensitivity of EDS was inadequate to detect a nitrogen signal. XPS was used to characterize the presence of nitrogen in the Ti₃C₂—NH₂ and Ti₃C₂—C₂H₅NH₂ samples.

FIG. 5C is an SEM image of the Ti₃C₂—NH₂ MXene in FIG. 5A. FIG. 5D is an SEM image of the Ti₃C₂—C₂H₅NH₂ MXene in FIG. 5B. This SEM implies that the Ti₃C₂—NH₂ and Ti₃C₂—C₂H₅NH₂ were layered with well-defined edges, meaning they were structurally consistent with MXenes. The MXenes had a uniform particle shape, size, and layers. The particle size of the Ti₃C₂—NH₂ was about 1 μm to about 30 μm. The particle size of the Ti₃C₂—C₂H₅NH₂ was about 1 μm to about 30 μm.

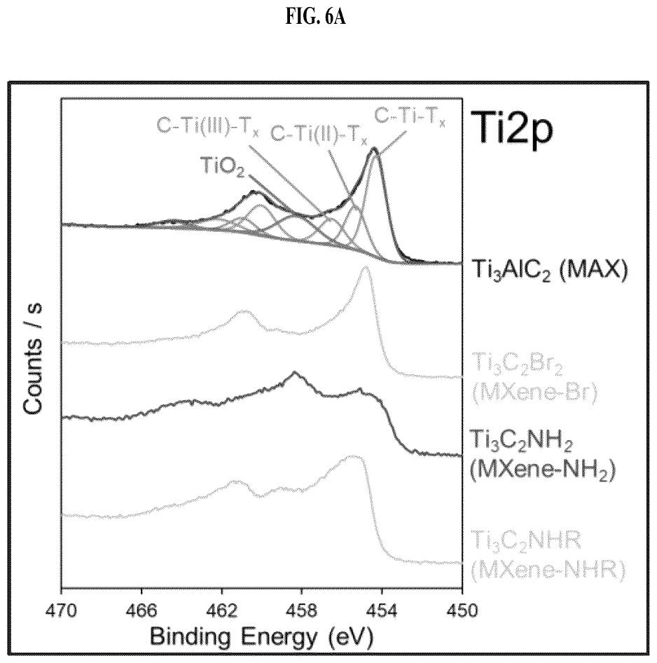

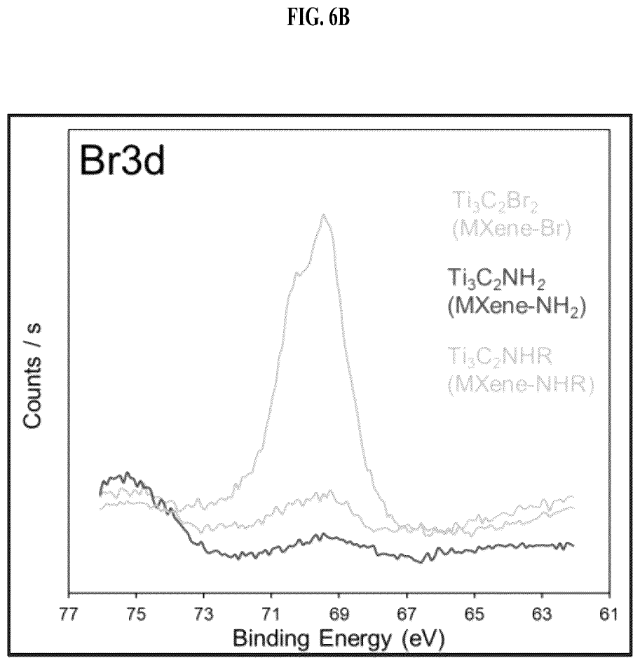

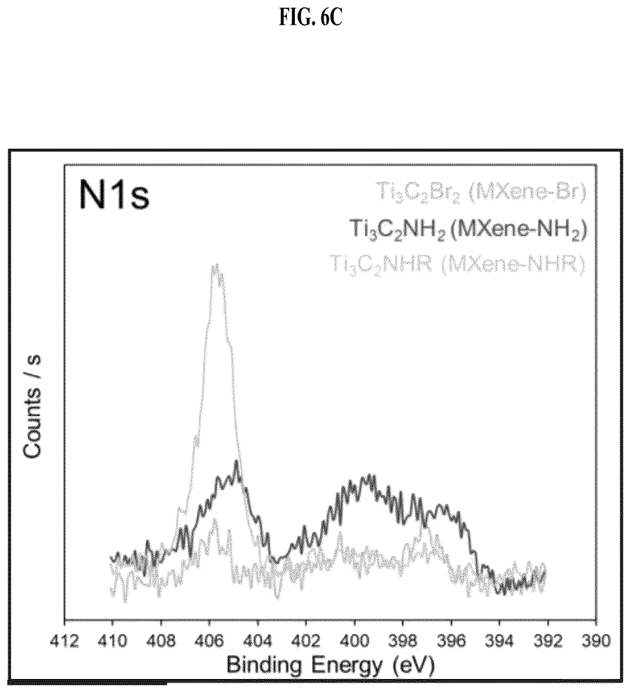

FIG. 6A is a graph of the Ti 2p peak in X-ray photoelectron spectroscopy (“XPS”) of the Ti₃C₂—NH₂ MXene in FIG. 5A and the Ti₃C₂—C₂H₅NH₂ MXene in FIG. 5B (referred to as “MXene-NHR”). FIG. 6B is a graph of the Br 3d peak in XPS of the Ti₃C₂—NH₂ MXene in FIG. 5A and the Ti₃C₂—C₂H₅NH₂ MXene in FIG. 5B (also referred to as “MXene-NHR”). FIG. 6C is a graph of the N is peak in XPS of the Ti₃C₂—NH₂ MXene in FIG. 5A and the Ti₃C₂—C₂H₅NH₂ MXene in FIG. 5B (also referred to as “MXene-NHR”). The Ti 2p XPS spectra indicated the presence of Ti—C species at about 455 eV throughout all four samples. The Br 3d spectra included a strong bromine peak for Ti₃C₂Br₂, while there was a weaker bromine peak for Ti₃C₂—NH₂ and Ti₃C₂—C₂H₅NH₂ indicating that the bromine termination was successfully substituted out. The N is spectra indicated that there was no nitrogen signal in the bromine-terminated MXene Ti₃C₂Br₂, and strong nitrogen signals for the Ti₃C₂—NH₂ and Ti₃C₂—C₂H₅NH₂ MXenes, further supporting the successful substitution of Br terminations with amine groups.

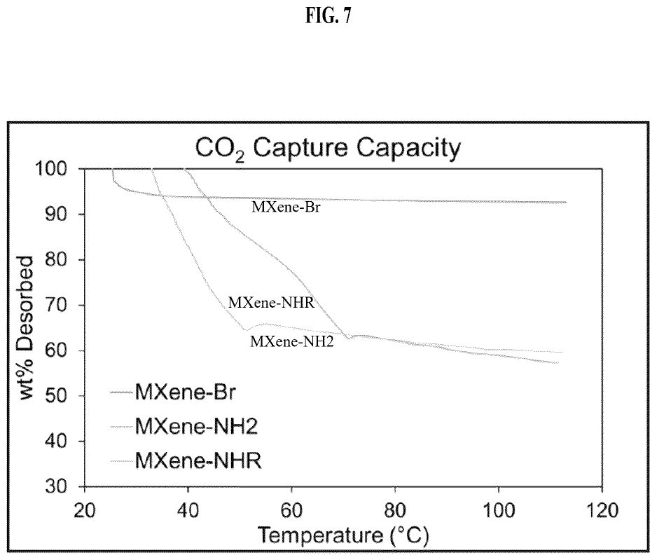

CO₂ Sorption/Desorption on Ti₃C₂—NH₂ and Ti₃C₂—C₂H₅NH₂ MXenes. FIG. 7 is a graph of CO₂ desorption from Ti₃C₂Br₂ MXene (also referred to as “MXene-Br”), Ti₃C₂—NH₂ MXene (also referred to as “MXene-NH₂”), and Ti₃C₂—C₂H₅NH₂ MXene (also referred to as “MXene-NHR”) as measured by thermogravimetric analysis (“TGA). FIG. 7 depicts temperature (° C.) versus wt. % loss as each MXene was heated to desorb CO₂, following saturation of the MXene with CO₂. The results from the TGA analysis in FIG. 7 are also shown in Table 1.

TABLE 1
TGA Results.

| | CO₂ Sorption Capacity | Regeneration Energy |
|---|---|---|
| MXene | (mmol CO₂/g MXene) | (kJ/kg CO₂) |
| Ti₃C₂Br₂ | 1.81 | 73.71 |
| Ti₃C₂—NH₂ | 15.37 | 66.58 |
| Ti₃C₂—C₂H₅NH₂ | 16.96 | 60.78 |

The TGA analysis indicated a loss of 7.37 wt. %, 40.35 wt. %, and 42.73 wt. % for the Ti₃C₂Br₂, Ti₃C₂—NH₂, and Ti₃C₂—C₂H₅NH₂, respectively, which is 1.81 mmol CO₂/g, 15.37 mmol CO₂/g, and 16.96 mmol CO₂/g, respectively. The regeneration energy calculated from the mass of CO₂ lost was 73.71 kJ/kg CO2, 66.58 kJ/kg CO2, and 60.78 kJ/kg CO2 for the Ti₃C₂Br₂, Ti₃C₂—NH₂, and Ti₃C₂—C₂H₅NH₂, respectively. The Ti₃C₂—C₂H₅NH₂ had more CO₂ desorption than the other samples.

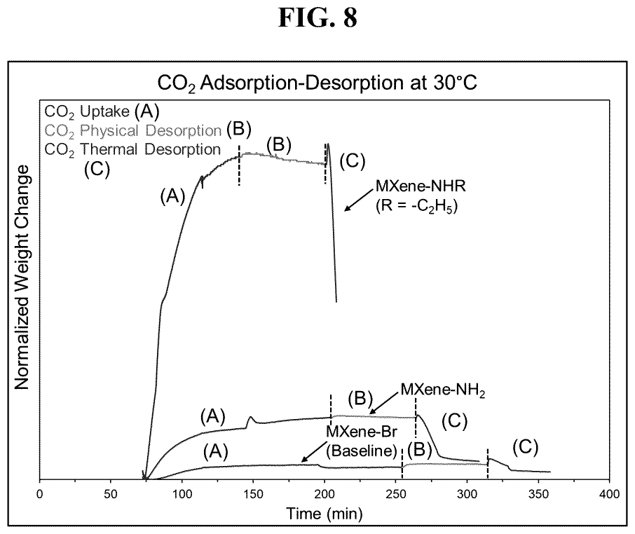

FIG. 8 is a graph of CO₂ adsorption and desorption from Ti₃C₂Br₂ MXene (“MXene-Br”), Ti₃C₂—NH₂ MXene (“MXene-NH₂”), and Ti₃C₂—C₂H₅NH₂ MXene (“MXene-NHR” where R is —C₂H₅) measured at 30° C. Analysis including CO₂ uptake, CO₂ physical desorption, and CO₂ thermal desorption. Results indicated MXene-NHR exhibited a sharp weight increase upon CO₂ exposure, consistent with chemisorption via amine groups. MXene-NH₂ also exhibited CO₂ sorption, but with a more modest and slower weight increase. Without being bound by any theory, this may suggest diffusion limitations that could be mitigated via MXene exfoliation. The MXene-Br was comparison data used as a baseline, showing only minimal CO₂ uptake, highlighting the distinct sorption capability introduced by amine modification.

In all cases, desorption included thermal activation since physical desorption was ineffective. Without being bound by any theory, this behavior is consistent with chemisorption-dominated CO₂ binding by amine-based sorbents.

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions, or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

What is claimed is:

1. A composition comprising:
a MXene comprising Tₓ, wherein Tₓ is a surface termination, the surface termination comprising NH₂, R¹NH₂, or a combination thereof, wherein R¹ is a C₁₋₅ alkyl group; and
a compound sorbed to the MXene, the compound comprising CO₂, H₂S, SO_{y}, or a combination of any two or more thereof, wherein y is 1 to 4.

2. The composition of claim 1, wherein the MXene is selected from M₂XTₓ, M₃X₂Tₓ, M₄X₃Tₓ, and M₅X₄Tₓ, wherein M comprises at least one transition metal and X is selected from carbon and nitrogen.

3. The composition of claim 2, wherein the at least one transition metal is selected from scandium, titanium, vanadium, chromium, yttrium, zirconium, niobium, molybdenum, hafnium, tantalum, and tungsten.

4. The composition of claim 1, wherein the MXene comprises Ti₃C₂NH₂, Ti₃C₂—C₂H₅NH₂, or a combination thereof.

5. The composition of claim 4, wherein the compound is CO₂.

6. The composition of claim 1, wherein the MXene is formed of particles of about 1 μm to about 100 μm as characterized by scanning electron microscopy.

7. A method comprising:
contacting a MXene with a compound while the MXene is at a first temperature of about −78° C. to about 40° C., thereby sorbing the compound to the MXene;
wherein the MXene comprises Tₓ, Tₓ is a surface termination, and the surface termination comprises NH₂, R¹NH₂, or a combination thereof, wherein R¹ is a C₁₋₅ alkyl group; and
wherein the compound comprises CO₂, H₂S, SO_{y}, or a combination of any two or more thereof, wherein y is 1 to 4.

8. The method of claim 7, further comprising cooling the MXene at the first temperature of about −78° C. to about 20° C.

9. The method of claim 7, wherein the first temperature is about −20° C. to about 10° C.

10. The method of claim 7, further comprising heating the MXene with the compound sorbed thereto at a second temperature of about 30° C. to about 1200 to desorb the compound from the MXene.

11. The method of claim 10, wherein the second temperature is about 70° C. to about 110° C.

12. The method of claim 7, wherein the MXene is selected from M₂XTₓ, M₃X₂Tₓ, M₄X₃Tₓ, and M₅X₄Tₓ, wherein M comprises at least one transition metal and X is selected from carbon and nitrogen.

13. The method of claim 12, wherein the at least one transition metal is selected from scandium, titanium, vanadium, chromium, yttrium, zirconium, niobium, molybdenum, hafnium, tantalum, and tungsten.

14. The method of claim 7, wherein the MXene comprises Ti₃C₂NH₂, Ti₃C₂C₂H₅NH₂, or a combination thereof.

15. The method of claim 14, wherein the compound is CO₂.

16. A system comprising:
a plurality of MXene particles comprising Tₓ, wherein Tₓ is a surface termination, the surface termination comprising NH₂, R¹NH₂, or a combination thereof, wherein R¹ is a C₁₋₅ alkyl group;
a vessel configured to contain the plurality of MXene particles, the vessel comprising at least one port for influx of a compound; and
a cooling device configured to cool the plurality of MXene particles at a first temperature of about −78° C. to about 40° C.;
wherein the compound comprises CO₂, H₂S, SO_{y}, or a combination of any two or more thereof, wherein y is 1 to 4.

17. The system of claim 16, wherein the cooling device is further configured to heat the plurality of MXene particles at a second temperature of about 30° C. to about 120° C.; or wherein the system further comprises a heater configured to heat the plurality of MXene particles at a second temperature of about 30° C. to about 120° C.

18. The system of claim 16, wherein the vessel is a column comprising two ports configured for flow of the compound through the column.

19. The system of claim 16, wherein the first temperature is about −20° C. to about 10° C.

20. The system of claim 16, wherein the plurality of MXene particles comprises Ti₃C₂NH₂, Ti₃C₂C₂H₅NH₂, or a combination thereof.
